(19) United States
(12) Patent Application Publication
(10) Pub. No.: US 2006/0156594 A1
(43) Pub. Date: Jul. 20, 2006

(54) Greeting card that unfolds into a bookmark and candle

(76) Inventor: Brent A. Dansby, Akron, OH (US)

Correspondence Address: Brent A. Dansby, 1725 Kingsley Ave, Akron, OH, 44313, US

(21) Appl. No.: 11/332,949

(22) Filed: Jan. 17, 2006

Related U.S. Application Data
(60) Provisional application No. 60/645,311, filed on Jan. 18, 2005.

(51) Int. Cl. G09F 1/00

(52) U.S. Cl. 40/124.16

(57) ABSTRACT

A combined candle/greeting card/bookmarker (5,3) to be used first as a candle/greeting card (5,3) and than as a bookmarker (3).

### CROSS REFERENCE TO RELATED APPLICATIONS

The present application claims to the priority date of provisional application titled, GREETING CARD THAT UNFOLDS INTO A BOOKMARK AND CANDLE, Ser. No. 60645311 filed Jan. 18, 2005

### FEDERALLY SPONSORED RESEARCH

Not Applicable

### SEQUENCE LISTING OR PROGRAM

Not Applicable

### FIELD AND BACKGROUND OF THE INVENTION

This invention relates to the field of greeting cards and greeting cards in combination with a candle and a bookmarker.

For centuries, people have adored the practice of expressing emotions through the giving of cards and candles. A standard greeting card of the traditional fold card variety does not incorporate a candle. Although the sale of candles and bookmarkers where greeting card are sold is common, A combined greeting card/candle/bookmarker has not been found in prior art.

### FIELD AND BACKGROUND OF THE INVENTION CONTINUED

U.S. Pat. No. 3,077,981 discloses a greeting card comprising two concentric plastic tube containers one within the other with a greeting card between the two containers, wrapped around the inner container which contains a candle. The preferred embodiment of the present invention has the advantages of being smaller, lighter and more suited for mailing; dispenses with the need and expense of plastic tubes; allows for the greeting card to be displayed flat rather than curved; and the candle is easier to light because in the present invention there is no tube around the candle. The preferred embodiment of the present invention further allows candle light to shine directly on the card, producing a more pleasing display.

U.S. Pat. No. 4,035,937 discloses a candle with grooves cut into it to hold a greeting card. The preferred embodiment of the present invention has the advantages over this prior art of being smaller, lighter and more suited for mailing, and prevents the greeting card from being damaged or obscured by flame or candle wax.

U.S. Pat. No. 6,817,122 discloses a greeting card/candle in which the candle is assembled from wax sheets by the recipient. The preferred embodiment of the present invention has the advantages of being smaller, lighter and more suitable for mailing. The present invention does not require assembly by the recipient to use the candle, and elements of the greeting card taught by the present invention are not consumed as the candle burns. The preferred embodiment of the present invention also allows for candle light to shine directly on the greeting card for a more pleasing display.

The forgoing advantages of an preferred embodiment of the present invention illustrate the need for a combined greeting card/candle/bookmarker.

### SUMMARY OF THE INVENTION

The present invention is a combined greeting card/candle/bookmarker comprising:
at least one card bearing at least one visual representation, said card comprising:
   at least one base area and
   at least one releaseably attached bookmarker area; and
   at least one candle assembly attached to said base area.

The invention may also incorporate any of the following features:
a fold line for oriented for bending said card into an L-shape.
a bookmarker area in which is releasably attached by a line of perforations.
a card made of flame resistant, self extinguishing vinyl material
a metal disk within plastic container for added stability.
a card assembly which comprises a candle mounted in a plastic container.
a plurality of fold lines oriented for folding said card into a mailable carton.

### BRIEF DESCRIPTION OF THE DRAWINGS

FIG. 1 is a top view of an embodiment of the invention prior to bending it into display position. A plastic cylinder which is flame resistant and holds a tea candle is attached to the said base area. 1 indicates the fold line where the card portion, which is made of flame resistant self extinguishing vinyl, is folded into the L-shaped display position. 2 indicates the line of perforations where the bookmarker may be detached.

FIG. 2 is a top view of an embodiment of the invention in its L-shaped display position. Shown is the top edge of the card, the base area, candle cylinder, and candle.

FIG. 3 is the front view of an embodiment of the invention in its L-shaped display position. Shown is the plastic candle cylinder, the top of the candle and wick, the card base, and vertical area of the card.

FIG. 4 is a back view of an embodiment of the invention in its L-shaped display position. Shown is the vertical portion of the card.

FIG. 5 is perspective view of an embodiment of the invention in its L-shaped display position. Shown is the perspective side edges of the card, the perspective of the candle cylinder, the top of the candle and wick, the base, and card area with example graphic

FIG. 6 is a top view of an embodiment of the invention in its L-shaped display position minus candle. Shown is the top edge of the card, the base area, plastic candle cylinder, and metal disk 10 for added stability.

### DETAILED DESCRIPTION OF THE DRAWINGS

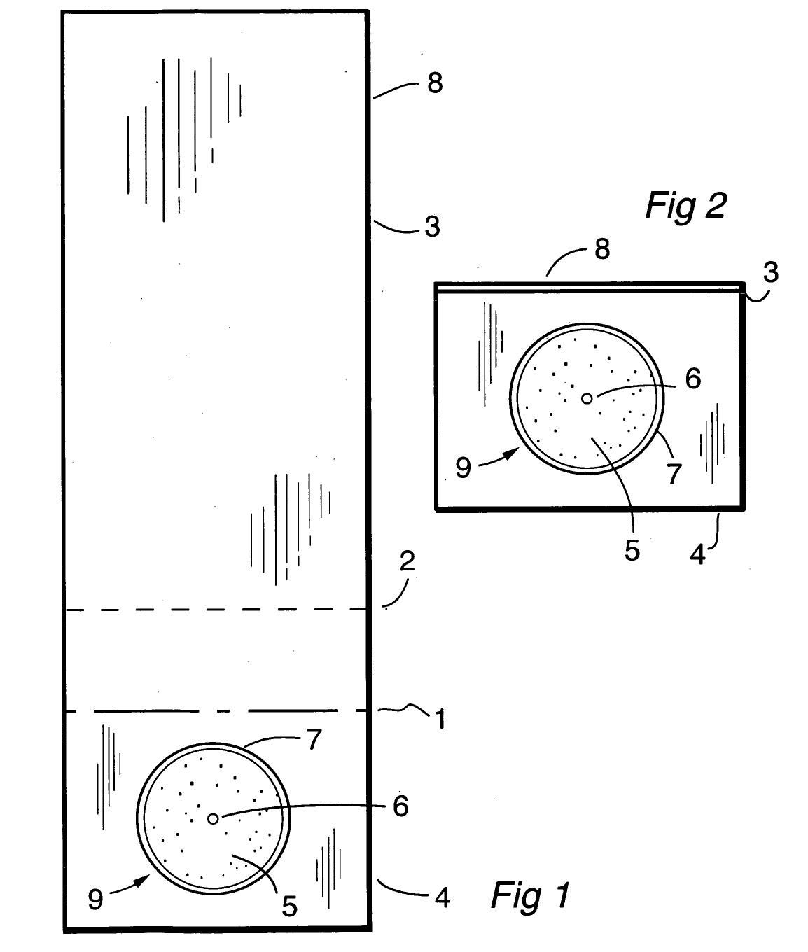

As shown in FIG. 1, one embodiment of a greeting card/candle/bookmarker comprises a card 8 with a candle assembly 9 attached to it. The card 8 may be made from a single piece of flame resistant, self-extinguishing vinyl and comprise a card/bookmark area 3 releasably attached to a base area 4 at a perforated line 2.

The candle assembly 9 may comprise a plastic cylinder 7 containing a tea candle 5 with a wick 6. The candle assembly 9 may be attached to the card by a glue dot.

Advantages of this embodiment include its light-weight and suitability for mailing in a small carton.

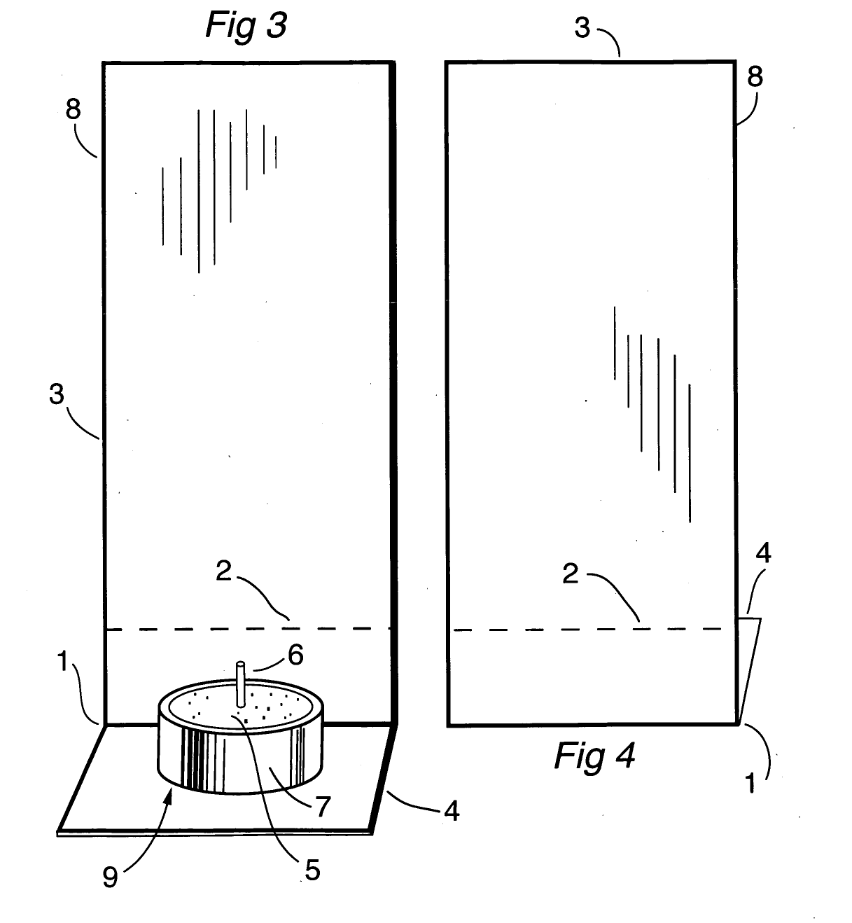

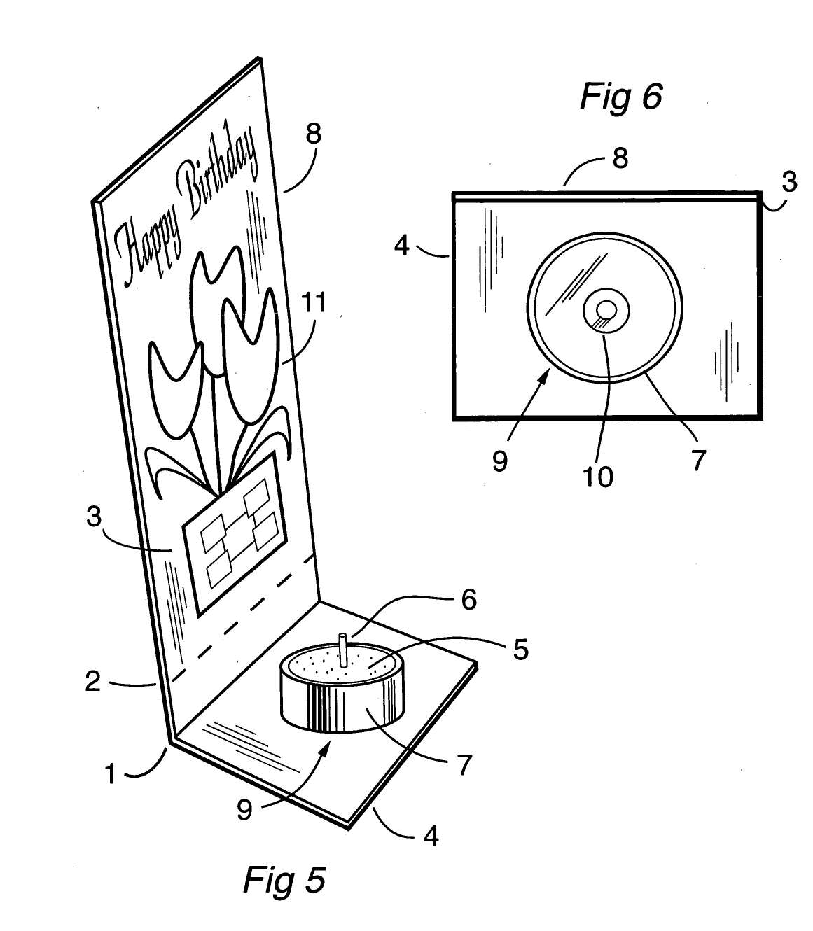

Also, the card 8 may be bent to an L-shape at the fold line 1 so that, with base area 4 on a flat surface, the card/bookmark area 3 is in a substantially upright position, as shown in FIGS. 2-6. In this display position, candlelight from tea candle 5 directly illuminates the card/bookmark area 3 for a pleasing display. 11 example of graphic.

Afterward, the card/bookmark area 3 can be detached from the base area 4 at the perforated line 2 to be used as a bookmarker and kept as a long lasting memento.

This embodiment of the invention has been described in considerable detail in order to enable one skilled in the art to practice the invention. However, the invention can be practiced with many other embodiments while still remaining within the scope of the claims.

What is claimed is

1. An apparatus comprising:
at least one card bearing at least one visual representation, said card comprising:
at least one base area, and
at least one releasably attached bookmarker area; and
at least one candle assembly attached to said base area.

2. The apparatus as in claim 1; wherein said card has a fold line oriented for bending said card into an L-shape.

3. The apparatus as in claim 1; wherein said book marker area is releasably attached by a line of perforations.

4. The apparatus as in claim 1; wherein said card is made of flame resistant, self-extinguishing vinyl material.

5. The apparatus as in claim 1; wherein said candle assembly comprises:
a candle mounted in a plastic container.

6. The apparatus as in claim 1; wherein said card has plurality of fold lines oriented for bending said card into a mailable carton.

7. The apparatus as in claim 1; wherein a separate mailable carton is included.

8. An apparatus comprising:
at least one card made of flame resistant, self-extinguishing vinyl material and bearing at least one visual representation, and card comprising:
at least one base and
at least one bookmarker area releasably attached by a line of perforations;
at least one candle assembly comprising:
an aromatic candle mounted in a plastic container
said candle assembly attached to said base area; and at least one fold line oriented for bending said card into an L-shape.
